(19) United States
(12) Patent Application Publication
(10) Pub. No.: US 2013/0067785 A1
(43) Pub. Date: Mar. 21, 2013

(54) PICTURE FRAME WITH REMOVABLE MOUNTING SYSTEM

(71) Applicants: Robert Davis, Corona, CA (US); Jennie Enholm, Laguna Hills, CA (US); Francis M. Yankello, Corona, CA (US)

(72) Inventors: Robert Davis, Corona, CA (US); Jennie Enholm, Laguna Hills, CA (US); Francis M. Yankello, Corona, CA (US)

(21) Appl. No.: 13/588,192

(22) Filed: Aug. 17, 2012

Related U.S. Application Data
(60) Provisional application No. 61/575,334, filed on Aug. 19, 2011.

(51) Int. Cl. A47G 1/06; B23P 11/00

(52) U.S. Cl. 40/781; 40/790; 29/525.01

(57) ABSTRACT

A picture frame comprises a frame member defining an opening and a front surface and a rear surface. First and second substantially parallel grooves are formed on either the front or rear surface, and at least one spline is provided which can be releasably located within the first or second grooves. Further, a method of mounting a work on a picture frame is provided and comprises placing the work face down on a work surface, and placing the frame member over the work so that the front surface of the frame member is touching the work. The work is folded over the edge of the frame member to be adjacent the rear surface of the frame member. A spline is inserted into the one of parallel grooves so as to capture the work in the groove by the force of the spline.

### CROSS REFERENCE TO RELATED APPLICATIONS

This application claims the benefit of U.S. Provisional Patent Application No. 61/575, 334 filed on Aug. 19, 2011, the contents of which are in corporative herein in their entirety.

### FIELD AND BACKGROUND OF THE INVENTION

This invention relates to a picture frame with a removable picture, poster or other fabric or material mounting system therefor.

More particularly, the invention relates to a frame for a picture, or other work, whether comprised of paper, fabric or other material, wherein the picture can be removably mounted to the picture frame. In one form of the invention, the picture frame can be constructed into a regular rectangular or other shape for holding the picture or work, and easily deconstructed into component pieces for its convenient storage and/or transportation.

Picture frames are a common and conventional mechanism for holding and hanging on a wall works of art, posters, photographs or other material (generally referred to in this specification as “works”) in a manner designed to best display the subject matter of the works. A typical picture frame comprises an upper portion, a lower portion and two side or lateral portions which are fixed to each other so as to define an assembly which is generally rectangular or square configuration, although other shapes and forms are possible. These portions define an opening or a space through which the work can be seen when attached to the picture frame. The picture frame further has a front surface and a rear surface, as well as an outer edge and an inner edge. In a conventional picture frame, the work is placed against or behind the rear surface on the picture frame so that it will be seen through the opening defined by the picture frame when the rear surface thereof is placed against, for example, a wall for hanging and display.

In the typical framing of a work, the work is placed up against the rear of the frame, or behind the rear of the frame, and may be held in position in different ways. For example, the work may be glued along its edges so as to adhesively engage the picture frame itself. In another example, the work may be placed against the picture frame and a backing of some type is applied to the rear surface of the picture frame so as to sandwich the work between the picture frame and the backing in a way which will hold the work in a desired position. Sometimes, the work is smaller than the opening in the picture frame, and other devices may be used to keep the work firmly and centered within the frame.

A picture frame and its associated work may be further enhanced by the use of backings, lining, glass or other elements and components.

### SUMMARY OF THE INVENTION

According to one aspect of the invention, there is provided a picture frame comprising a frame member defining an opening, the frame member having a front surface and a rear surface, first and second substantially parallel grooves on either the front and rear surface, and at least one spline which can be releasably located within the first or second grooves.

Preferably, the first and second grooves are on the rear surface of the frame member. The first and/or second grooves may form a continuous groove on the rear surface of the frame member, or they may comprise a series of separated grooves on the rear surface of the frame member.

In one embodiment, the spline comprises a resilient material which is malleable and adapted to fit within the groove so that a part of a work mounted on the picture frame is sandwiched by the groove and the spline. There may be a single continuous spline used in the first or second grooves, or a plurality of fixed length splines may be used.

In one form, the work is mounted over the front surface of the frame member, folded over the frame member so as to cover at least a part of the rear surface of the frame member, the spline being placed in the first or second grooves so as to capture a part of the work between the groove and the spline. In another form, the first and second grooves are on the front surface of the frame member and the work is mounted over the front surface of the frame member, the spline being placed in the first or second grooves so as to capture a part of the work between the groove and the spline.

According to a further aspect of the invention, there is provided a picture frame comprising a frame member defining an opening, the frame member having a front surface and a rear surface, a groove on either the front and rear surface, and at least one spline which can be releasably located within the groove.

According to yet a further aspect of the invention, there is provided a method of mounting a work on a picture frame having a frame member with a front surface, a rear surface and a pair of substantially parallel grooves on the rear surface, the method comprising: placing the work face down on a work surface; placing the frame member over the work so that the front surface of the frame member is touching the work such that the edges of the work extend beyond the outer edges of the frame member; folding the edges of the work over the edge of the frame member so that the edges of the work are adjacent the rear surface of the frame member; and inserting at least one spline into the one of the pair of parallel grooves further from the edge of the frame member so as to capture the edge of the work in the groove by the force of the spline.

In one form, at least one spline is inserted into the other of the pair of parallel grooves so as to capture the work in the groove by the force of the spline. In another form, a plurality of splines are inserted into the groove at various select positions on the rear surface of the frame member.

In yet a further aspect of the invention, there is provided a picture frame kit comprising: a frame member having a front surface and a rear surface and defining an opening, the rear surface having a groove extending therein; at least one spline for inserting in the groove so as to mount a work on the frame member and capture the work in the groove by the spline. The kit may further comprise a storage receptacle for accommodating the picture frame kit when in a dismantled or compacted condition, as well as at least one work for mounting on the frame member.

In one aspect, therefore, the invention is for a picture frame which is configured and structured to releasably hold a work thereon. The picture frame comprises a top piece, a bottom piece, and a pair of side pieces which are assembled with respect to each other to generally provide a square or rectangular frame having a front surface and a rear surface. This assembly may, in accordance with the invention, the although a permanent nature, or it may be more temporary in which the various components can be fairly easily dismantled and compacted until needed once more.

The rear surface of the assembled picture frame has a series of elongate grooves or channels which, in conjunction with one or a plurality of strip members which are accommodated within the grooves or channels, capture and maintain the work in the selected and desired position relative to the picture frame.

Preferably, two parallel grooves or channels are provided on the rear surface of the picture frame. The grooves in conjunction with the strip members allow the work to the fastened to the picture frame in a manner in which the work has been appropriately tensioned over the picture frame, so that there will be little or no sagging of the work, which is relatively tautly held on the picture frame to provide optimal viewing of the work.

The grooves or channels on the rear surface of the picture frame are preferably constructed so as to form a continuous groove around or near the periphery of the entire picture frame. Thus, the grooves in any one of the top piece, bottom piece, and side pieces will be continuous, providing an uninterrupted groove or channel around the entire picture frame. However, a plurality of non-continuous grooves or channels may be formed in the picture frame in a further embodiment of the invention, the noncontinuous grooves preferably being selectively positioned on the picture frame to allow the work to be positioned and mounted so that there are no wrinkles of the work when mounting has been completed.

In a preferred embodiment, the work to be mounted on the picture frame will typically be placed on the front surface of the picture frame, and folded over the outer edges of the picture frame so that the edges or peripheries of the work are adjacent the rear surface. Further, the edges of the work will extend over the channels or grooves in the rear surface. The strip members may then be pushed into the grooves or channels such that the edges of the work are captured between the strip members and the grooves and held in the grooves. In the embodiment of the invention having a pair of parallel grooves, the edge of the work may be placed in either one of the grooves in the first instance, although improved tensioning may be achieved by first capturing the edge of the work in the groove further from the edge of the picture frame, and thereafter using the strip member to further capture the edge of the work in the groove near the edge of the picture frame, which will preferably have the effect of further stretching the work in the picture frame to provide an improved mount with minimal sag or wrinkles.

Preferably, the strip members are of the flexible or resilient type. Therefore, since they are flexible and resilient, they can be merged or waste into the grooves in a manner which will from the capture the edge of the work therein. The strip members may distend be tractile and pliant within the grooves so that they full of groove applying pressure to the sides thereof, and the work captured between the strip members and the sides of the groove will therefor be reasonably firmly held without sliding out.

There may be one continuous strip member extending all of way around the picture frame, or a series of strip members of desired length can be used in the groove at selected intervals to best achieve the mounting of the work on the picture frame. However, in one embodiment, it will be appreciated that the strip members may be less resilient, and may be comprised of harder materials such as wood, which may be completely or partially splined to provide enhanced traction.

In one form of the invention, the work itself may be marked with lines or other markings to enable and guide the user to optimally position the work relative to the picture frame. Thus, for example, the work may have solid lines, dots, or staggered lines at the approximate or anticipated point or line where the work will be captured in one or both of the grooves. Further, the work may have additional markings corresponding to the outer edge of the frame, to further assist the user in the proper positioning and mounting of the work.

### BRIEF DESCRIPTION OF THE DRAWINGS

Reference is now made to the drawings in which:

FIG. 1 is a partial view of a frame in accordance with one aspect of the invention;

FIG. 2 is a partial view of unassembled arms of the picture frame;

FIG. 3 is a first end view of a piece of the picture frame;

FIG. 4 is a second end view of a piece of the picture frame;

FIG. 5 is a schematic front view of a work for mounting on the picture frame;

FIG. 6 is a detailed view of the picture frame showing the grooves;

FIG. 7 is a section through a piece of the picture frame showing a work mounted thereon;

FIG. 8 is a front view of the picture frame showing one embodiment of the invention; and

FIG. 9 is a front schematic view of a picture frame in accordance with a further aspect of the invention.

### DETAILED DESCRIPTION OF THE INVENTION

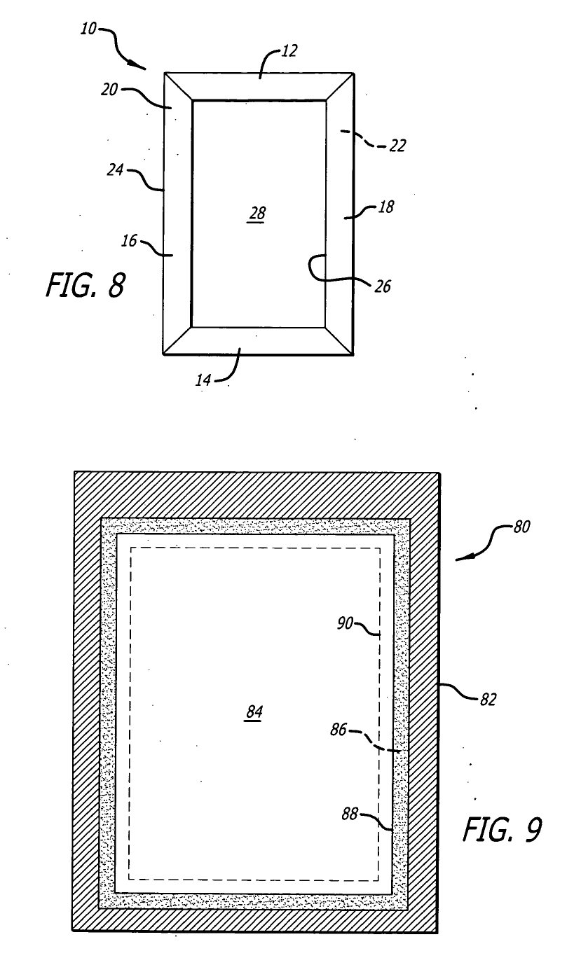

With reference to the drawings, there is shown in the various illustrations a picture frame 10 of the invention, and the work mounted thereon. The picture frame 10 generally comprises an upper piece 12, a lower piece 14 and side or lateral pieces 16 and 18 (see FIG. 8 of the drawings). The picture frame 10, and each of these respective pieces, include a front surface 20, rear surface 22, an outer edge 24 and an inner edge 26. The picture frame 10 defines an opening or space 28 or space in or around which the work is situated or framed. As shown in FIG. 8 of the drawings, the frame is rectangular in shape, but may be square, oval, hexagonal, or any other shape which will facilitate use of the invention.

The front surface 20 may have appropriate ornamental and design features such as moldings, carvings and the like, and may also be angled. The invention is not limited to any such configuration.

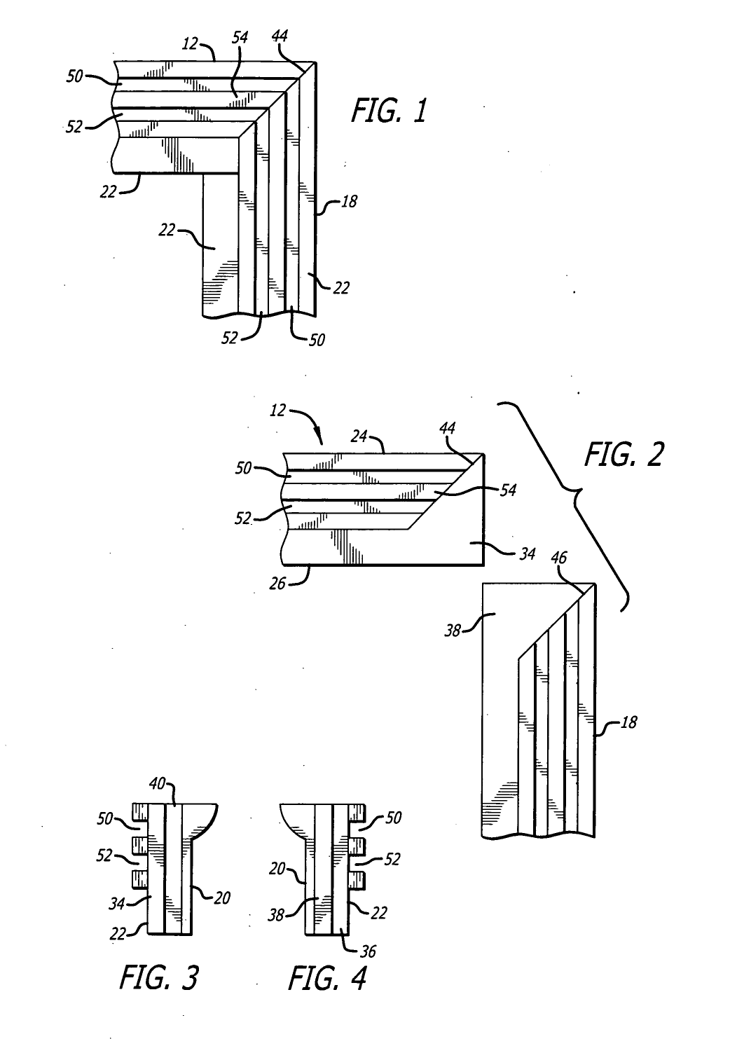

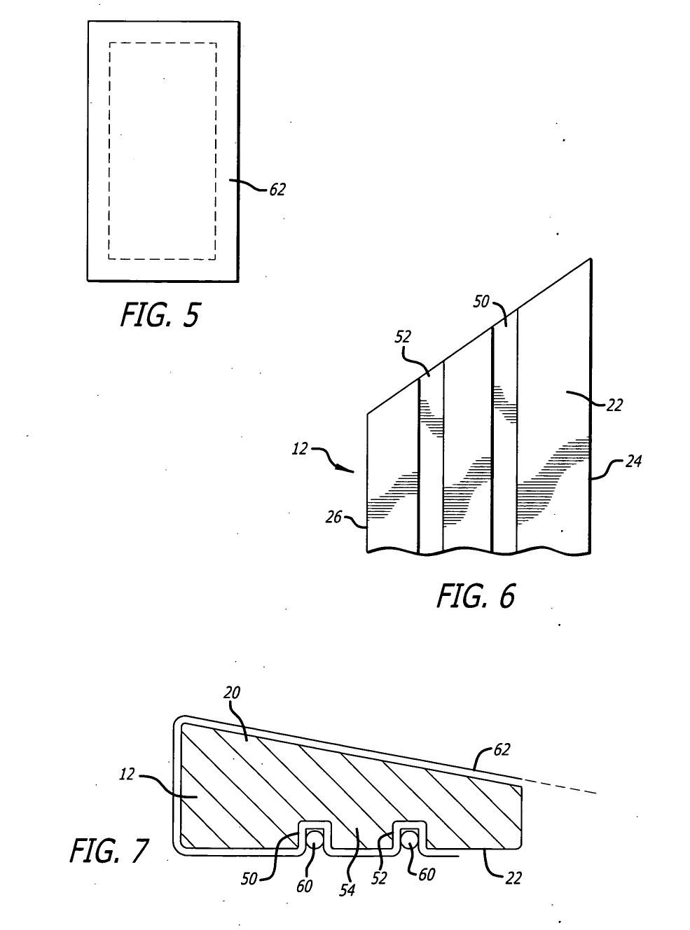

FIGS. 1 and 2 of the drawings show a detail of the rear surface 22 of two adjacent pieces, such as upper piece 12 and a side piece 18. FIG. 1 shows these two pieces 12 and 18 in a joint or assembled condition, while FIG. 2 shows these pieces in the unassembled condition in which the frame has been dismantled. The upper piece 12 has a tongue or joint 34 which is received within the groove 36 of the side piece 18. Further, the side piece 18 has a tongue or joint 38 which is received within the groove 40 the upper piece 12. These dovetail or other type joints and grooves are constructed with appropriate tolerances to firmly hold the upper piece 12 and side piece 18 (as well as other adjacent pieces) together. When so assembled, the 45° diagonal 44 of the upper piece 12 engages the 45° diagonal 46 of the side piece 18 to form a secure and clean joint between these respective pieces.

The groove or channel structure on the rear surface 22 of each of the pieces 12, 14, 16 and 18 will now be described. The structure is described with respect to only one of the pieces, but similar and corresponding structure is found on all of the pieces. Further, the groove or channel in any one piece will preferably, but not necessarily, have an end thereof which is next to the corresponding end of a groove or channel of its adjacent piece.

The upper piece 12 includes a first longitudinal channel or groove 50 and a second longitudinal channel or groove 52. The first longitudinal groove 50 is nearer the outer edge 24 of the upper piece 12, while the second longitudinal groove 52 is nearer the inner edge 26 of the upper piece 12. A groove break or intermediary section 54 is formed between the first and second longitudinal grooves 50 and 52 respectively. The grooves 50 and 52 run along the entire length of the upper piece 12 up to and including the 45° diagonal 44. The grooves 50 and 52 are open at their ends, so that they are continuous and uninterrupted when adjacent with corresponding grooves in the side pieces 16 and 18.

Note that in other embodiments of the invention, the channels or grooves 50 and 52 may not be continuous, but may be a series of spaced discontinuous grooves. The spacing or distance between grooves may vary along the length of any piece of a picture frame, or from one picture frame of the invention to another.

One or a plurality of splines 60 are provided. Each spline 60 is preferably comprised of a rubber and resilient material, configured and sized so as to be snugly and preferably malleably received within the grooves 50 and 52. Each spline 60 is inserted into a respective groove 50 or 52, with the work 62 captured between the spline 60 and the groove 50 or 52 in a manner which fixes the work 62 within the groove 50 or 52. The resiliency of these splines 60 may cause them to bend or otherwise conform at least partially to the shape of the groove, so that a secure fit will be achieved, and that the spline 60 will not fall out on the groove in the normal course of events. Generally, each of the grooves 50 and 52 has a somewhat square shape in cross-section, although a groove or grooves which have different shapes may also be used to receive the spline.

In one form, these splines 60 may have longitudinal ribs formed on the surface to provide enhanced traction and malleability, and so that the spline 60 will better engage with and remain in the groove more firmly.

In operation, a work 62 is attached to the picture frame 10 in a releasable manner. The spline and groove connection will not damage the work, only slightly bending it near its edges, which may be superfluous to the work itself, and present only for the purposes of attachment to a frame of the invention. Once the picture frame 10 has been appropriately assembled by slotting to each other the various pieces 12, 14, 16 and 18, attachment of the work 62 to the picture frame 10 may commence. Note that the various pieces comprising the picture frame 10 can be more securely attached to each other, if desired, by the application of glue or adhesive, or by the use of nails to fasten the pieces to each other. Thus, the picture frame 10 may be permanently assembled, or it can be dismantled for storage when not in use.

In one version of the present invention, the mounting operation is initiated by first placing the work on a work surface, such as a table, face down so that the art or content of the work is not seen. The backside of the work will therefore be facing upward, and be exposed. The work 62 may have, as mentioned above, lines or markings thereon which assist the user in placing the work relative to the picture frame. Otherwise, if the work itself does not have lines or markings, a separate template may be provided, based on the properties and dimensions of the picture frame 10, and the template is used, once more, at this point so as to properly position and locate the work 62 relative to the picture frame 10.

The work may also have markings in the form of dots, staggered lines or a continuous line along those points where the work will be inserted in the grooves 50 and 52. Thus, the user will be assisted by being able to overlie the relevant part of the work 62 on the groove 50 or 52 into which it is to be inserted. Note that these markings or templates may be in place of, or in addition to, the other markings described above which identify the outer edge of the frame 10.

Each frame may come with its own template corresponding to its size and dimensions so that the user can utilize this template over the back of the work 62 to be attached to the picture frame 10. Such a template can be stored and used more than once, each time a new work 62 is mounted to the picture frame 10. This arrangement may also be very useful when the work 62 is sold independent of the picture frame, and the user requires guidance as to how to fit such work on the picture frame in an optimal relationship. The template may be a conventional paper sheet with appropriate markings, or any other type of template or guide for assisting the user.

If lines corresponding to the perimeter or outer edge 24 of the picture frame 10 are provided on the back of the work 62, the picture frame 10 is positioned, with the front surface 20 facing downward, over the work 62 so that the picture frame 10 falls within the lined template marked on the back of the work 62. The rear surface 22 of the frame 10 will thus the facing upwards, visible to the user. It will be appreciated that the area of the work 62 is greater than the area of the picture frame as defined by the outer edge 24. Therefore, the work 62 will extend beyond the outer edge 24 in this mounting operation by a distance more or less equal to the thickness of the frame, and at least a distance which takes it up to the groove 50 nearest the outer edge 24, and the depth or breadth of the various pieces.

The edges of the work 62 along its entire perimeter are then folded over the outer edge 24 of the picture frame 10, and folded again so as to overlie the rear surface 22. At this point, it will also be appreciated that the folded over portion of the work 62 will also lie over the first longitudinal groove 50, and preferably both the first and second longitudinal grooves 50 and 52. That part of the work 62 overlying second longitudinal groove 52 is then pushed into the groove 52 and secured therein by means of one continuous or a plurality of splines 60, as may be best suited to the circumstances. In a preferred form, a multiplicity of splines 60 will be used, and each of these may, in one embodiment, be approximately 1 to 2 inches long and spaced from each other in the groove 52 a few inches apart. Clearly, the size and number of splines 60 needed will depend on the nature of the work, its weight and thickness, and other parameters, and the invention is thus not limited to any one form or the use of these splines 60.

Once the edge of the work 62 has been locked into the second longitudinal groove 52 around the perimeter of the picture frame 10, that part of the work 62, or selected portions thereof depending on the need for tensioning of the work, which overlies the first longitudinal groove 50 may thereafter be placed in the groove 50 using splines 60, either singly or in a plurality, to make sure the edge of the work remains therein. Once more, the number of splines 60, the length and spacing thereof may be adjusted and determined according to the nature of the work.

One benefit of the double groove or channel arrangement described herein is the ability to properly tension the work 62 over the picture frame 10. Therefore, once the work 62 has been attached using splines 60 capturing the work in the second longitudinal groove 52, the work 62 may not be sufficiently tightly mounted on the picture frame 10, an additional tensioning would be appropriate. Depending upon the depths and dimensions of the groove 50, this can easily be achieved by locating the work 62 in the groove 50, making its mounting over the picture frame 10 a little more taut, resulting in an improved and clean looking display of the work 62.

Reference is now made to FIG. 9 of the drawings which shows a further embodiment of the invention. FIG. 9 shows a picture frame assembly 80 comprising a frame 82 of generally rectangular shape. FIG. 9 shows the front of the frame 82, and a work 84 has been attached thereto. In this embodiment, a groove 86 extends around the periphery of the frame 82, in a somewhat similar manner to the groove or channel as described in previous embodiments, and located on the rear surface of the frame. A spline 88 is placed in the groove so as to capture the work 84 and attach it to the frame 82. The edge of the work 84 may be trimmed where it extends outwardly beyond the spline 88 to give an overall neat impression. In FIG. 9, the dotted line 90 shows the position of the inner edge of the frame 82, located behind the work 84.

The spline 88 the maybe colored, textured or otherwise configured so as to provide an artistic effect. In this embodiment, a further mechanism is shown whereby the work may therefore be attached to the frame 82. It should be noted that the front face of the frame may also have two parallel channels, continuous or otherwise, as shown and described with respect to the rear surface of the frame, in order to permit not only the proper tensioning of the work within the frame, but also a more decorative or artistic feature, such as when splines all different color or ornamentation are used. Further, a particular frame may have one or more channels on either or both the front and rear surface of the frame so that, when channels are on both surfaces, the user has the option of selecting how to mount the work in a given situation.

Yet another option for mounting a work on the picture frame of the invention would be to place the work, which covers the opening of the picture frame, directly against the rear surface of the picture frame. In this embodiment, the work would not be folded over the frame. With the work placed against the rear surface of the picture frame, the work can then be secured to the picture frame by pushing down splines into the groove of the frame, at the same time capturing the work therebetween in much the same manner as has been described in previous embodiments. In this manner, the work would be splines against the rear surface of the frame, and the frame would then, of course, the visible around the work. In such an embodiment, the frame may be selected or configured so as to have greater visual appeal, since the frame would now be part of the display which includes the work itself.

While the picture frame is preferably comprised of wood, any suitable material or a combination of materials may be used in its construction. Thus, the frame may be comprised or partially comprised of plastic, aluminum, metal, composite, as possible examples only.

The invention is not limited to the details described herein. While two grooves are described and illustrated herein, it is possible that additional grooves may be provided along all or part of the periphery of the picture frame. Furthermore, the grooves 50 and 52 need not be continuous and uninterrupted around the periphery of the picture frame 10, but intermittent grooves provided. This may apply with respect to either of the first or second longitudinal grooves, or such additional grooves as may be provided. These splines 60 themselves may vary in shape and structure. Thus, for example, these splines may be tubular in shape, or they may be spherical or near-spherical. Tabs or pulls may be provided and inserted between the spline and the work, which the user can then grasp when it is desired to remove the spline from the groove.

As mentioned, the various pieces of the frame may in one embodiment be capable of being dismantled, and any appropriate dovetail or other type of joint provided for convenient assembly. A carry bag may also be provided to accommodate the disassembled pieces for transportation and storage. In addition, the picture frame may be part of a kit, including the carry bag, picture hanging nails, protective covers and the like.

The work itself may be a paper or cardboard poster, a fabric work, or photographic paper to name just a few examples. The only limitation on the types of work which may be mounted on the picture frame will be those that due to thickness or other structural characteristics make such mounting difficult or impossible.

Other variations and additions are now briefly described. The work may be comprised of canvas, paper, fabric, plastic, metal foils and films. The groove depth and profile may be suitably configured to accommodate the fabric thickness and cord or spline diameter. Further, the grooves or channels may be of differing size and fit to facilitate a proper fit for a range of media thicknesses. The innermost groove can be used to hide the edge of or facilitate trimming of the media to provide a clean finished look to the assembly, at the back side of the frame. The groove itself can have any one of a number number of profiles, such as square, rectangular, with a radius applied to the former profiles.

Further, the groove may be profiled with an undercut to better lock the cord or spline within the groove. The spline compliancy may be set or selected so as to require no tool, or, if desired, a simple hand tool for placing the spline in the groove may be used to more effectively lock or locate the spline in the groove.

The spline or cord may be either of a continuous length, or it may be cut by the customer, each cut piece having a suitable length as selected. Further, grooves can be placed on the front face of the frame to window-like design the frame.

The invention thus permits, in one aspect, progressive stretching and/or tightening of the media or work by first placing the spline in the most interior groove and then placing the spline into progressively exterior grooves (facing the back side of the frame) in order to tighten the work in the frame to a preferred tension.

1. A picture frame comprising a frame member defining an opening, the frame member having a front surface and a rear surface, first and second substantially parallel grooves on either the front and rear surface, and at least one spline which can be releasably located within the first or second grooves.

2. A picture frame as claimed in claim 1 wherein the frame member comprises a top piece, a bottom piece, and a pair of side pieces which are assembled with respect to each other to provide a square or rectangular frame having the front surface and the rear surface.

3. A picture frame as claimed in claim 1 wherein the first and second grooves are on the rear surface of the frame member.

4. A picture frame as claimed in claim 3 wherein the first and/or second grooves form a continuous groove on the rear surface of the frame member.

5. A picture frame as claimed in claim 3 wherein the first and/or second grooves comprise a series of separated grooves on the rear surface of the frame member.

6. A picture frame as claimed in claim 2 wherein the top piece, bottom piece and side pieces are permanently fixed to each other to form the frame member.

7. A picture frame as claimed in claim 2 wherein the top piece, bottom piece and side pieces are releasably fixed to each other to form the frame member so that they can be dismantled for compacting the frame member for storage or transportation.

8. A picture frame as claimed in claim 1 wherein the spline comprises a resilient material which is malleable and adapted to fit within the groove so that a part of a work mounted on the picture frame is sandwiched by the groove and the spline.

9. A picture frame as claimed in claim 1 wherein a single continuous spline is used in the first or second grooves.

10. A picture frame as claimed in claim 1 wherein a plurality of fixed length splines are used in the first or second grooves.

11. A picture frame as claimed in claim 3 for receiving a work, the work being mounted over the front surface of the frame member, folded over the frame member so as to cover at least a part of the rear surface of the frame member, the spline being placed in the first or second grooves so as to capture a part of the work between the groove and the spline.

12. A picture frame as claimed in claim 1 for receiving a work, wherein the first and second grooves are on the front surface of the frame member and the work is mounted over the front surface of the frame member, the spline being placed in the first or second grooves so as to capture a part of the work between the groove and the spline.

13. A picture frame comprising a frame member defining an opening, the frame member having a front surface and a rear surface, a groove on either the front and rear surface, and at least one spline which can be releasably located within the groove.

14. A picture frame as claimed in claim 13 wherein the groove is on the rear surface of the frame member.

15. A picture frame as claimed in claim 14 further comprising a second groove on the rear surface of the frame member which is substantially parallel to the groove.

16. A method of mounting a work on a picture frame having a frame member with a front surface, a rear surface and a pair of substantially parallel grooves on the rear surface, the method comprising:
placing the work face down on a work surface;
placing the frame member over the work so that the front surface of the frame member is touching the work such that the edges of the work extend beyond the outer edges of the frame member;
folding the edges of the work over the edge of the frame member so that the edges of the work are adjacent the rear surface of the frame member; and
inserting at least one spline into the one of the pair of parallel grooves further from the edge of the frame member so as to capture the edge of the work in the groove by the force of the spline.

17. A method as claimed in claim 16 further comprising inserting at least one spline into the other of the pair of parallel grooves so as to capture the work in the groove by the force of the spline.

18. A method as claimed in claim 16 wherein a plurality of splines are inserted into the groove at various select positions on the rear surface of the frame member.

19. A method as claimed in claim 16 wherein a single continuous spline is inserted into the groove, the continuous spline located in the groove and extending substantially around the periphery of the frame member.

20. A picture frame as claimed in claim 1 comprising three substantially parallel grooves formed on the rear surface of the frame member.

21. A picture frame kit comprising:
a frame member having a front surface and a rear surface and defining an opening, the rear surface having a groove extending therein;
at least one spline for inserting in the groove so as to mount a work on the frame member and capture the work in the groove by the spline.

22. A picture frame kit as claimed in claim 21 comprising a frame member having to substantially parallel grooves on the rear surface thereof.

23. A picture frame kit as claimed in claim 21 further comprising a storage receptacle for accommodating the picture frame kit when in a dismantled or compacted condition.

24. A picture frame kit as claimed in claim 21 further comprising at least one work for mounting on the frame member.
